(19) United States
(12) Patent Application Publication
(10) Pub. No.: US 2025/0292140 A1
(43) Pub. Date: Sep. 18, 2025

(54) ARTIFICIAL INTELLIGENCE ("AI") GUARDRAILS USING QUANTUM COMPUTING

(71) Applicant: Bank of America Corporation, Charlotte, NC (US)

(72) Inventor: Maharaj Mukherjee, Poughkeepsie, NY (US)

(21) Appl. No.: 18/607,747

(22) Filed: Mar. 18, 2024

(51) Int. Cl. G06N 10/60

(52) U.S. Cl. CPC G06N 10/60

(57) ABSTRACT

Methods, systems and apparatus for maintaining a stable artificial intelligence (“AI”) model are provided. The methods may include detecting an input query entered into an input field of the AI model. Data points and algorithms used by the AI model to generate the response to the input query may be identified. The methods may include generating a simulated response using a quantum computing platform. The simulated response may be compared with the response generated by the AI model. Based on the comparing, AI-based deviations, quantum-based deviations and a shared set of parameters may be identified. Using the AI-based deviations, the quantum-based deviations and the shared set of parameters a guardrail may be created. The guardrail may be used to maintain the AI model at a stable operating level. The guardrail may delete data points and algorithms that are determined to correspond to the AI-based deviations and the quantum-based deviations.

### FIELD OF TECHNOLOGY

Aspects of the disclosure relate to artificial intelligence (“AI”) and quantum computing.

### BACKGROUND OF THE DISCLOSURE

Artificial intelligence models are trained using data sets. The datasets are referred to as training data. The training data dynamically updates and improves AI models. AI models receive data. AI models learn from experience via iterative processing and algorithmic training. AI models include progressive learning algorithms. The progressive learning algorithms ingest the data. The progressive learning algorithms analyze the ingested data. The progressive learning algorithms identify correlations and patterns within the data. The progressive learning algorithms use the identified correlations and patterns to generate outputs. AI models update the progressive learning algorithms based on the generated outputs curated from the analyzed correlations and patterns.

AI models also include machine learning algorithms. Machine learning algorithms enable AI models to learn from experience. AI models include deep learning algorithms. Deep learning algorithms utilize neural networks. Neural networks use interconnected nodes or neurons in a layered structure to analyze data and generate outputs.

AI models test and measure the accuracy of the generated outputs. AI models are provided with labeled testing datasets. AI models measure the accuracy of the generated outputs by comparing the generated outputs to the labels previously applied to the testing datasets. Based on comparing the generated outputs to the labeled testing datasets, AI models update the progressive learning algorithms to improve accuracy of the AI models.

At times, deviations within the data and/or the algorithms may impact the generated outputs of the AI model. The generated outputs may become skewed because of the deviations within the data and/or algorithms. The deviations within the data and/or algorithms may distort the training and testing of the AI model. The skewed outputs and distorted training and testing of the AI model may cause the AI model to operate at an unstable operating level. Operating at an unstable operating level may include producing untrue and/or unreliable outputs.

It would therefore be desirable to provide a system to detect and delete the deviations within the data and/or algorithms. However, due to the complex nature of AI models and neural networks, it is generally challenging and resource consumptive to identify the deviations within the data and/or algorithms using classical computing devices.

Quantum computing is the use of quantum-mechanical phenomena such as superposition, spin and entanglement to perform computations. A bit in a quantum computer is comparable to a bit in a classical computer. Quantum computing differs from classical computing in such a way that a qubit can be in a zero state and a one state at the same time. Quantum computing provides a viable approach for controlling and monitoring dynamic AI. For example, quantum computing systems may be as fast or faster than AI systems and, therefore, may be able to effectively monitor and control data being output by AI models without slowing down the AI model.

It would therefore be desirable to provide a quantum-based system to identify deviations within the data and/or algorithms included in the AI model. It would further be desirable to provide a quantum-based system for maintaining the AI model at a stable operating level.

### SUMMARY OF THE DISCLOSURE

Systems, apparatus and methods for maintaining a stable artificial intelligence (“AI”) model are provided.

The AI model may operate on a silicon-based computing platform. The silicon-based computing platform may include a network of one or more computing devices. Computing devices may include desktop computers, laptops, smartphones, tablets, mainframe computers, supercomputers, minicomputers and/or any other suitable computing devices. The network may include an edge network, a local area network (“LAN”), a wide area network (“WAN”), a decentralized network, a cloud-based network or any other suitable network. The silicon-based computing platform may be a classical computing system operating using binary digits and/or bits.

The methods may include using a quantum computing platform. A quantum computing platform may include a quantum processor. The quantum processor may operate using quantum bits (“qubits”). The quantum computing platform may include cooling hardware. The cooling hardware may be used to maintain the qubits within a few thousandths of a degree of absolute zero (kelvin). The qubits may be cooled to eliminate thermal noise and vibrations, which may destroy the information contained in the qubits.

The methods may include executing the AI model. The methods may include executing the AI model on the silicon-based computing platform. The methods may include executing the AI model on a third-party system. The AI model may be executed by a user of the silicon-based computing system. The AI model may be executed by a user of the quantum computing system. The AI model may be executed by a user of the third-party system.

The methods may include identifying one or more data points and algorithms for maintaining the AI model at a stable operating level. The methods may include identifying the one or more data points and algorithms for maintaining the AI model at a stable operating level using the quantum computing platform. A stable operating level may include an operating level at which the AI model generates outputs that are consistent, within a predetermined threshold, with corresponding inputs. The identifying of the one or more data points and algorithms may be executed in parallel with the executing of the AI model.

The methods may include capturing training data used to train the AI model. The training data may be received from different sources. The training data may be received from entity-specific sources. The training data may be received from public sources. The training data may be received from private sources. Training data that is received from public sources may include information that can be shared, used, reused and/or redistributed without restriction. Training data that is received from private sources may include personal, personally identifiable, financial, sensitive or information of a specific person or entity.

The methods may include detecting an input query. The input query may be a prompt entered into an input field of the AI model. The prompt may be entered by a user. The prompt may be a question. The prompt may be a set of instructions. The prompt may be any suitable form of task for entering into an AI model. In response to detecting the input query, methods may include tracking the AI model. The AI model may be tracked as the AI model generates a response to the input query.

The AI model may use a plurality of data points and algorithms to generate plurality of responses to different input queries. Each data point and algorithm within the AI model may be weighted. Weighting each data point and algorithm may include assigning an importance level to each data point and/or algorithm. The importance level may be a numeric score. The importance level may be an alphanumeric score. The importance level may be any suitable scoring metric. Based on the assigned importance level, the AI model may generate a response using data points and algorithms with an importance level greater than a predetermined threshold importance level. The AI model may dynamically update itself after generating each response. Dynamically updating itself may include reweighting each data point and algorithm depending whether it was used when generating the response to the input query.

For example, the AI model may include multiple data points and algorithms that may be used to generate a response for a single input query. Some data points and algorithms from the multiple data points and algorithms may be used to generate a first response. Other data points and algorithms from the multiple data points and algorithms may be used to generate a second response. The first response may not overlap with the second response. The AI model may select and use data points and algorithms from the multiple data points and algorithms to generate the response. The selection may be based on the level of importance assigned to each data point and algorithm included the multiple data points and algorithms.

The tracking may include identifying, from the training data, a plurality of data points used to generate the response. The AI model may include various data points that may be used to generate responses. Depending on the input query, the AI model may use different combinations of different pluralities of data points to generate a response. The tracking may include identifying which plurality of data points are being used to generate the response. The tracking may include monitoring a plurality of algorithms, executing within the AI model, used to generate the response. The AI model may include various algorithms that may be used to generate responses. Depending on the input query, the AI model may use different combinations of different pluralities of algorithms to generate different responses. The tracking may include monitoring which plurality of algorithms is being used to generate the response.

Using the data identified from tracking the AI model, the quantum-based computing platform may generate a simulated response. The simulated response may be generated by simulating the AI model. The simulated response may be a quantum-based response.

The methods may include generating a response to the input query. The response may be generated by the AI model. The response may be an AI-based response.

Simulating the AI model may include copying the plurality of data points used to generate the AI-based response. The plurality of data points used to generate the AI-based response may include bits. The simulating may include recreating the copied data points using qubits in the place of bits. Simulating the AI model may include copying the plurality of algorithms used to generate the AI-based response. The plurality of algorithms used to generate the AI-based response may include classical algorithms created using a series of binary instructions. The series of binary instructions may be used to solve problems or perform tasks. Simulating the AI model may include recreating the copied algorithms using quantum algorithms. Quantum algorithms may include algorithms based on amplitude amplification, algorithms based on the quantum Fourier transform, algorithms based on quantum walks and/or any other suitable quantum algorithms. Each algorithm may include a series of one or more quantum gates, such as but not limited to, identity gates, Pauli gates, controlled gates, phase shift gates, Hadamard gates, swap gates and Toffoli gates.

The methods may include receiving a response to the input query from the silicon-based computing platform. The response may be generated by the AI model. The response may be an AI-based response.

The methods may include comparing the quantum-based response with the AI-based response.

In response to the comparing, the methods may include identifying AI-based deviations. The AI-based deviations may be included in a first subset of the plurality of data points and algorithms. The first subset may correspond to the data points and algorithms used to generate the AI-based response. The AI-based deviations may be features of the AI-based response that are specific to the AI model.

In response to the comparing, the methods may include identifying quantum-based deviations. The quantum-based deviations may be included in a second subset of the plurality of data points and algorithms. The second subset may correspond to the data points and algorithms used to generate the quantum-based deviations. The quantum-based deviations may be features of the quantum-based deviations that are specific to the quantum computing model. The AI-based deviations may not overlap with the quantum-based deviations.

In response to the comparing, the methods may include identifying a shared set of parameters. The shared set of parameters may be included in a third subset of the plurality of data points and algorithms. The third subset may correspond to overlap between the AI-based response and the quantum-based response. Overlap between the AI-based response and the quantum-based response may include any data points or algorithms that were used to generate both the AI-based response and the quantum-based response.

The methods may include transmitting the AI-based deviations, the quantum-based deviations and the shared set of parameters from the quantum computing platform to the silicon-based computing platform. The methods may include using the AI-based deviations, the quantum-based deviations and the shared set of parameters to create a guardrail. The guardrail may be used to maintain the AI model operating at a stable operating level. The guardrail may include a set of conditions. The set of conditions may enable the AI model to identify which data points and algorithms are included in the first subset, the second subset and the third subset. The set of conditions may delete data points and algorithms that are determined to be included in the first subset and the second subset. The set of conditions may delete the first and second subsets. The set of conditions may confirm and score data points and algorithms that are determined to be included in the third subset. Scoring the data points and algorithms included in the third subset may include assigning and/or reassigning an importance level to the data points and algorithms.

Because the data points and algorithms included in the third subset are included in both the AI-based response and the quantum-based response, the data points and algorithms included in the third subset may be assigned/reassigned a high importance level. A high importance level may indicate a high level of use, greater than a threshold level of use, of the data points and algorithms. The AI model may identify data points and algorithms that are used less frequently. The AI model may assign the data points and algorithms that are used less frequently with a low importance level. A low importance level may indicate a low level of use, lower than a threshold level of use, of the data points and algorithms. The AI model may update itself based on the scoring of the data points and algorithms.

The methods may further include updating the guardrail. When updating the guardrail, the set of conditions may be a first set of conditions. When updating the guardrail, the methods may include updating the guardrail with a second set of conditions. The second set of conditions may be determined based on subsequent input queries input into the AI model. The second set of conditions may not overlap with the first set of conditions. The second set of conditions may overlap with the first set of conditions. The second set of conditions may be determined by determining AI-based deviations, quantum-based deviations and shared parameters from subsequent input queries being input into the AI model. As long as subsequent input queries are being input, the quantum computing platform may continually update the guardrails.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows yet another illustrative diagram in accordance with principles of the disclosure;

FIG. 5 shows yet another illustrative diagram in accordance with principles of the disclosure;

FIG. 6 shows yet another illustrative diagram in accordance with principles of the disclosure; and

FIG. 7 shows yet another illustrative diagram in accordance with principles of the disclosure.

### DETAILED DESCRIPTION OF THE DISCLOSURE

Systems, apparatus and methods for maintaining a stable artificial intelligence (“AI”) model are provided.

The apparatus may include a silicon-based computing platform. The silicon-based computing platform may include computing hardware such as central processing units (“CPUs”), graphical processing units (“GPUs”), arithmetic logic units (“ALUs”), power supply units (“PSUs”), random access memory (“RAM”), read only memory (“ROM”), disk drives, motherboards, monitors, peripheral devices and/or any other suitable computing hardware. The silicon-based computing platform may include computing firmware such as an operating system (“OS”), application software, utility software and/or any other suitable software operating using binary digits and/or bits. The silicon-based computing platform may include a network. The silicon-based computing platform may be included in a network. The network may be an edge network, a local area network (“LAN”), a wide area network (“WAN”), a decentralized network, a cloud-based network and/or any other suitable network.

The silicon-based computing platform may be configured to operate the AI model. The AI model may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. AI models may update the progressive learning algorithms based on the generated outputs curated/retrieved from the analyzed correlations and patterns.

The AI models may include machine learning algorithms. Machine learning algorithms may enable AI models to learn from experience without specific instructional programming. The AI model may include deep learning algorithms. Deep learning algorithms may utilize neural networks. Neural networks may use interconnected nodes or neurons in a layered structure to analyze data and generate outputs.

The apparatus may include a quantum computing platform. The quantum computing platform may include quantum-based hardware such as a quantum processor, quantum memory, cooling hardware and/or any other suitable quantum hardware. The quantum computing platform may include quantum-based firmware. Quantum-based firmware may include a set of protocols using high-performing quantum bits (“qubit”) to create unique quantum algorithms.

Quantum-based computing platforms may be associated with improved speed and efficiency over silicon-based computing platforms. For example, silicon-based computing platforms represent data in bits, which can be either 0 or 1. Quantum-based-computing platforms use qubits which utilize superposition (i.e., the ability to be in multiple states at the same time until it measured) to allow for a state of 0, 1 and/or any probability of being 0 or 1. The probabilities can be manipulated using matrix-based quantum gates, which are analogous to classical logic gates. Qubits are therefore able to represent many more data possibilities than a bit-based system of the same size. This may allow for greater speed and less memory usage than silicon-based computing systems.

The silicon-based computing platform may be in electronic communication with the quantum-based computing platform. The silicon-based computing platform may be in electronic communication with the quantum-based computing platform via a wireless connection. The silicon-based computing platform may be in electronic communication with the quantum-based computing platform via a wired connection. The quantum-based computing platform may include a controller interface. The controller interface may enable wired or wireless communications with other computing platforms. Wireless connections may include Bluetooth, Wi-Fi, Zigbee™, satellite or any other suitable wireless connections. Wired connections may include ethernet cables, fiber optic cables, coaxial cables and/or any other suitable wired connections.

The quantum computing platform may capture training data used to train the AI model. The training data may be received from different sources. The training data may be received from entity-specific sources. The training data may be received from public sources. The training data may be received from private sources. Training data received from public sources may include information that can be shared, used, reused and/or redistributed without restriction. Training data received from private sources may include personal, personally identifiable, financial, sensitive or information of a specific person or entity.

The quantum computing platform may detect an input query. The input query may be a prompt entered into an input field of the AI model. The input query may be a question. The input query may be set of instructions. The input query may be any suitable prompt entered into the AI model. The input query may be self-generated. The input query may be entered by a user of the AI model.

In response to a detection of the input query, the quantum-based computing platform may identify a plurality of data points used by the AI model to generate a response to the input query. The plurality of data points may be identified from the training data. In response to a detection of the input query, the quantum-based computing platform may monitor a plurality of algorithms executing within the AI model. The quantum-based computing platform may monitor the plurality of algorithms to determine which algorithms are being used by the AI model to generate the response to the input query.

The AI model may use different data points and algorithms to get different responses to different input queries. Each data point and algorithm within the AI model may be weighted. Weighting each data point and algorithm may include assigning an importance level to each data point and algorithm. The importance level may be a numeric score. The importance level may be an alphanumeric score. The importance level may be any suitable labeling metric. Based on the assigned importance level, the AI model may use data points and algorithms with a specific importance level when generating a response. The AI model may dynamically update itself after generating each response. Dynamically updating itself may include reweighting each data point and algorithm depending whether it was used when generating the response to the input query.

For example, the AI model may include multiple data points and algorithms that may be used to generate a response for a single input query. Some data points and algorithms from the multiple data points and algorithms may be used to generate a first response. Other data points and algorithms from the multiple data points and algorithms may be used to generate a second response. The first response may not overlap with the second response. The AI model may select and use data points and algorithms from the multiple data points and algorithms to generate the response. The selection may be based on the level of importance assigned to each data point and algorithm from the multiple data points and algorithms.

The quantum computing platform may generate a simulated response. The simulated response may be generated by simulating the AI model. The simulated response being a quantum-based response. Simulating the AI model may include using the quantum computing platform to copy the plurality of data points identified as being used to generate the AI-based response. The quantum computing platform may recreate the copied data points using qubits. The quantum computing may convert the bits included in the data points into qubits.

Simulating the AI model may include using the quantum computing platform to copy the plurality of algorithms used to generate the AI-based response. The quantum computing platform may recreate the copied algorithms using quantum algorithms. Quantum algorithms may include algorithms based on amplitude amplification, algorithms based on the quantum Fourier transform, algorithms based on quantum walks and/or any other suitable quantum algorithms. Each algorithm may include a series of one or more quantum gates, such as, but not limited to, identity gates, Pauli gates, controlled gates, phase shift gates, Hadamard gates, swap gates and Toffoli gates.

The quantum computing platform may receive a response to the input query from the silicon-based computing platform, via the wired or wireless connection. The response may be generated by the AI model. The response may be an AI-based response.

In response to receiving the AI-based response, the quantum computing platform may execute a comparison between the quantum-based response and the AI-based response.

The comparison may identify AI-based deviations. The AI-based deviations may be included in a first subset of the plurality of data points and algorithms. The first subset may correspond to the data points and algorithms used to generate the AI-based response. The AI-based deviations may be features of the AI-based response that are specific to the AI model.

The comparison may identify quantum-based deviations. The quantum-based deviations may be included in a second subset of the plurality of data points and algorithms. The second subset may correspond to the data points and algorithms used to generate the quantum-based deviations. The quantum-based deviations may be features of the quantum-based deviations that are specific to the quantum computing model.

The AI-based deviations may not overlap with the quantum-based deviations.

The comparison may identify a shared set of parameters. The shared set of parameters may be included in a third subset of the plurality of data points and algorithms. The third subset may correspond to overlap between the AI-based response and the quantum-based response. Overlap between the AI-based response and the quantum-based response may include any data points or algorithms that were used to generate both the AI-based response and the quantum-based response.

The quantum computing platform may transmit, via the wired or wireless connections, the AI-based deviations, the quantum-based deviations and/or the shared set of parameters to the silicon-based computing platform.

The silicon-based computing platform may use the AI-based deviations, the quantum-based deviations and the shared set of parameters to create a guardrail. The guardrail may be used to maintain the AI model at a stable operating level. A stable operating level may include an operating level at which the AI model generates outputs that are consistent, within a predetermined threshold, with corresponding inputs.

The guardrail may include a set of conditions. The set of conditions may include instructions to delete data points and algorithms that are determined to be within a predetermined threshold of the AI-based deviations and the quantum-based deviations. The set of conditions may include deleting data points and algorithms included in the first subset and the second subset. The set of conditions may include instructions to confirm and score data points and algorithms that are determined to be within a predetermined threshold of the shared set of parameters. The set of conditions may include instructions to confirm and score data points and algorithms included in the third subset. Scoring the data points and algorithms may include assigning and/or reassigning an importance level to the data points and algorithms.

Because the data points and algorithms included in the third subset were included in both the AI-based response and the quantum-based response, the data points and algorithms may be assigned/reassigned a high importance level. A high importance level may indicate a greater than a threshold level of use, of the data points and algorithms. The AI model may identify data points and algorithms that are used less frequently. The AI model may assign the data points and algorithms that are used less frequently with a low importance level. A low importance level may indicate a less than a predetermined threshold of use of the data points and algorithms. The AI model may update itself based on the scoring of the data points and algorithms.

The quantum computing platform may update the guardrail. When the quantum computing platform updates the guardrail the original set of conditions may be relabeled as a first set of conditions. Upon labeling the original set of conditions is a first set of conditions, the quantum computing platform may update the guardrail with a second set of conditions. The second set of conditions may not overlap with the first set of conditions. The second set of conditions may overlap with the first set of conditions. The second set of conditions may be determined by determining AI-based deviations, quantum-based deviations and shared parameters from subsequent input queries being input into the AI model. As long as subsequent input queries are being input, the quantum computing platform may continually update the guardrail. The AI model may be updated on a schedule, such as after a certain number of inputs, a certain input size, after a predetermined time period and/or any other suitable scheduled update.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

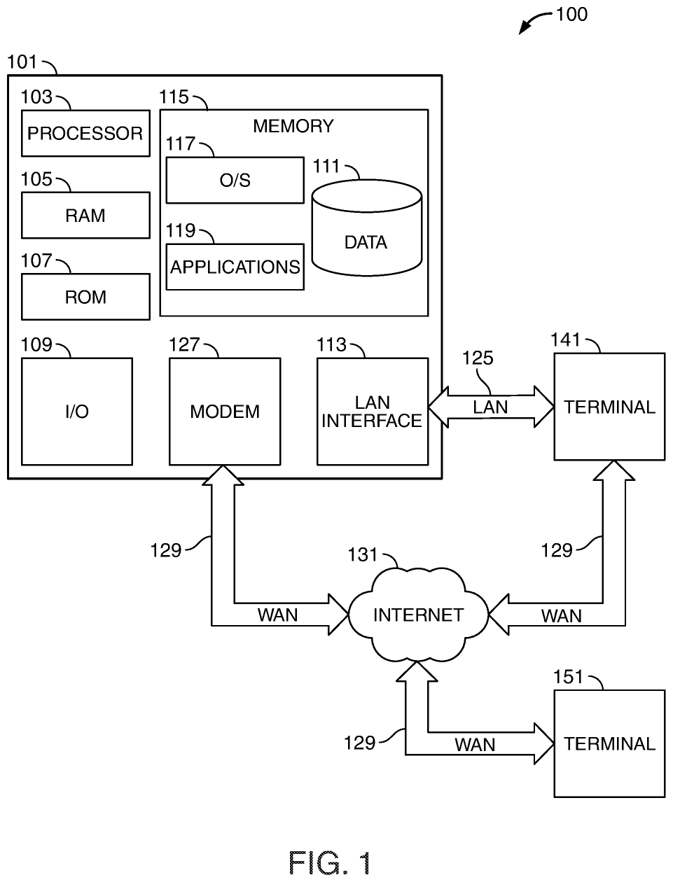

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

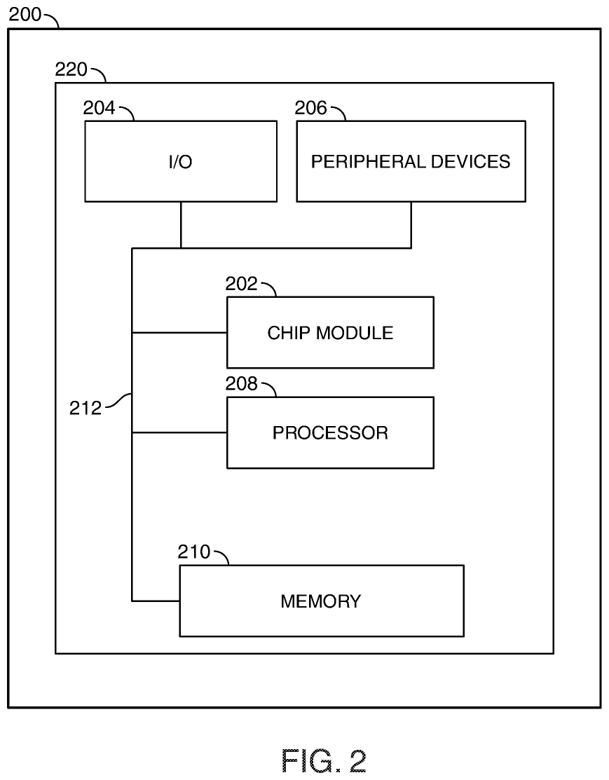

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

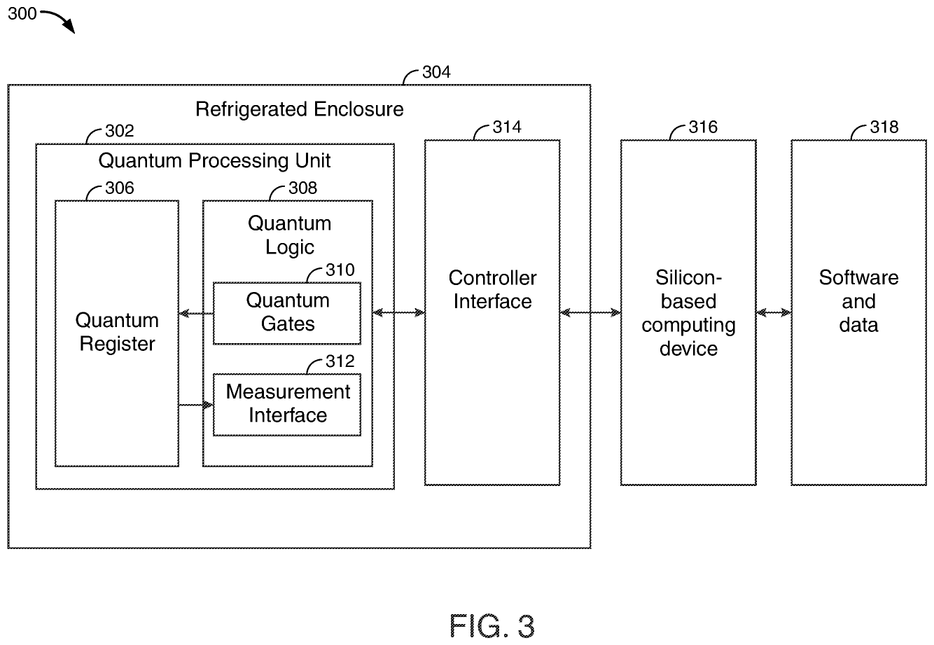

FIG. 3 shows illustrative block diagram of system 300. System 300 may include quantum processing unit 302. Quantum processing unit 302 may be processing unit that relies on quantum principles to perform tasks. Quantum processing unit 302 may include quantum register 306. Quantum processing unit 302 may include quantum logic 308. Quantum logic 308 may include quantum gates 310 and measurement interface 312.

Quantum register 306 may be comprised of qubits. Each qubit may have a distinct state of either zero or one, like a classical bit. However, unlike a classical bit, a qubit may have a superposition state. The superposition state may be a state in which the qubit exists as all possible states simultaneously. In order to retain the qubits in a superposed state, the qubits must be maintained at a degree close to absolute zero (kelvin). Refrigerated enclosure 304 may maintain the qubits at a degree close to absolute zero (kelvin).

Quantum gates 310 may include quantum algorithms, such as algorithms based on amplitude amplification, algorithms based on the quantum Fourier transform, algorithms based on quantum walks and/or any other suitable quantum algorithms. Each algorithm may include a series of one or more quantum gates, such as but not limited to identity gates, Pauli gates, controlled gates, phase shift gates, Hadamard gates, swap gates and Toffoli gates. Measurement interface 312 may measure a state of each qubit after being processed by the algorithms included in quantum gates 310. The measured state of each qubit may be a finite state.

The measured state may be transmitted to controller interface 314. Controller interface 314 may enable information to be transmitted between quantum processing unit 302 and silicon-based computing device 316. The measured state may be transmitted to silicon-based computing device 316. Silicon-based computing device 316 may include software and data 318. Software and data 318 may be used to process the measured state that was transmitted from quantum processing unit 302. Silicon-based computing device 316 may transmit data included in software and data 318 to controller interface 314. Controller interface 314 may transmit the data to quantum processing unit 302 to be processed and analyzed.

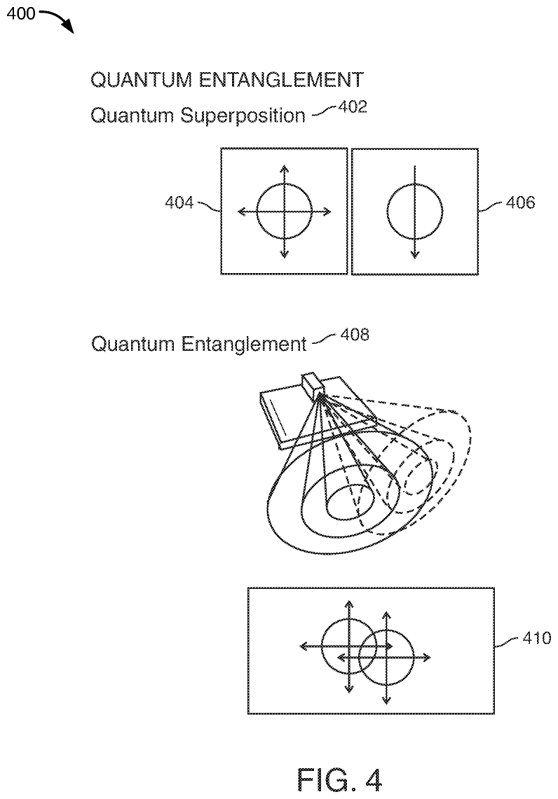

FIG. 4 shows illustrative diagram 400. Illustrative diagram 400 may have one or more features in common with system 300. Illustrative diagram 400 may include quantum superposition, as shown at 402. The rules of quantum physics state that an unobserved quantum particle, such as a photon, exists in all possible states simultaneously, as shown at 404. However, when observed or measured, the quantum particle collapses into one state, as shown at 406 (spin-down).

Quantum entanglement, shown at 408, may occur when two quantum particles become connected. A laser beam fired through a certain type of crystal can cause individual photons to be split into pairs of entangled photons. A pair of entangled particles may be shown at 410.

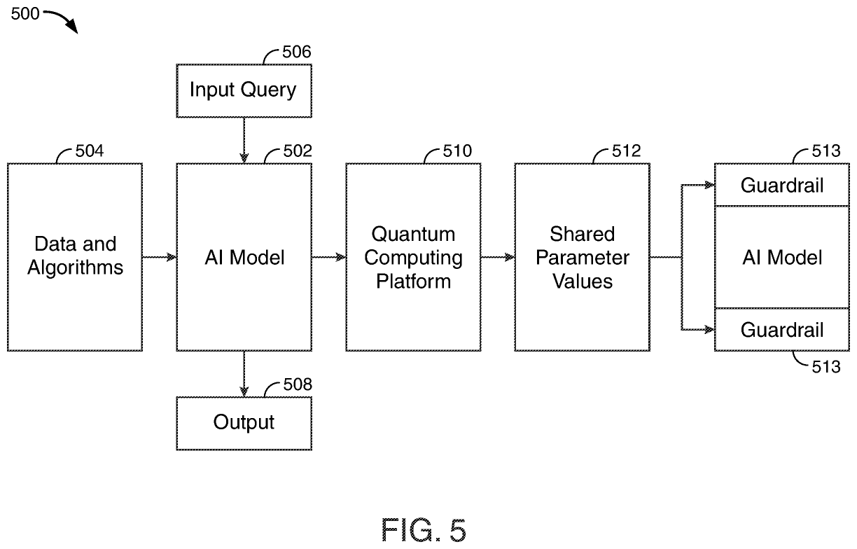

FIG. 5 shows illustrative block diagram of system 500. System 500 may have one or more features in common with one or more of system 100, apparatus 200, and system 300. System 500 may include AI model 502. AI model 502 may include data and algorithms 504. In response to receiving input query 506, AI model 502 may use data and algorithms 504 to generate output 508. In response to detecting input query 506, quantum computing platform 510 may monitor AI model 502, as AI model 502 generates output 508. Quantum computing platform 510 may monitor which of data and algorithms 504 are being used to generate output 508.

Based on the monitoring, quantum computing platform 510 may identify shared parameter values 512. Shared parameter values 512 may include data points and algorithms that both AI model 502 and quantum computing platform 510 have determined to be necessary in generating output 508. Based on shared parameters values 512, guardrails 513 for AI model 502 may be determined. Guardrails 513 may determine which data points and algorithms included in data and algorithms 504 should be used for outputs to subsequent input queries.

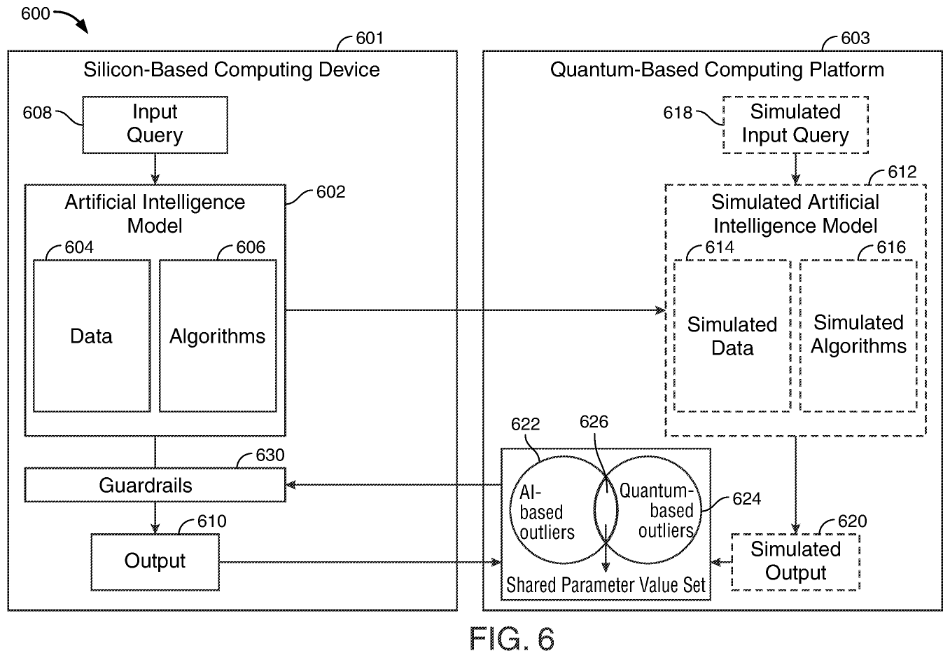

FIG. 6 shows illustrative diagram of system 600. System 600 may have one or more features in common with system 500. Silicon-based computing device 601 may execute AI model 602. AI model 602 may include data 604 and algorithms 606. In response to a detection of input query 608 at AI model 602, quantum-based computing platform 603 may create simulated AI model 612. Creating simulated AI model 612 may include copying and recreating data 604 as simulated data 614. Data 604 may be encoded in bits. Simulated data 614 may be encoded qubits. Creating simulated AI model 612 may include copying and recreating algorithms 606 as simulated algorithms 616. Algorithms 606 may be classical computing algorithms created using binary logic gates. Simulated algorithms 616 may be quantum computing algorithms created using quantum logic gates. Creating simulated AI model 612 may include creating simulated input query 618.

Using simulated input query 618, quantum-based computing platform 603 may generate simulated output 620. Simulated output 620 may be generated using simulated data 614 and simulated algorithms 616. After generating simulated output 620, simulated output 620 may be compared to output 610. Output 610 may be generated by AI model 602 using data 604 and algorithms 606.

Comparing simulated output 620 to output 610 may identify quantum-based outliers 624, AI-based outliers 622, and shared parameter value set 626. Output 610 may include data and algorithms specific to output 610. Simulated output 620 may include data and algorithms specific to simulated output 620. Output 610 and simulated output 620 may include data and algorithms overlapping between output 610 and simulated output 620. Data and algorithms specific to output 610 may correspond to AI-based outliers 622. Data and algorithms specific to simulated output 620 may correspond to quantum-based outliers 624. Data and algorithms overlapping between output 610 and simulated output 620 may correspond to shared parameter value set 626.

Quantum-based outliers 624, AI-based outliers 622 and shared parameter value set 626 may be transmitted to silicon-based computing device 601. Silicon-based computing device 601 may use quantum-based outliers 624, AI-based outliers 622 and shared parameter value set 626 to create guardrails 630. Guardrails 630 may include a set of conditions. The set of conditions may delete data and algorithms corresponding to either quantum-based outliers 624 or AI-based outliers 622. The set of conditions may confirm and approve data and algorithms corresponding to shared parameter value set 626.

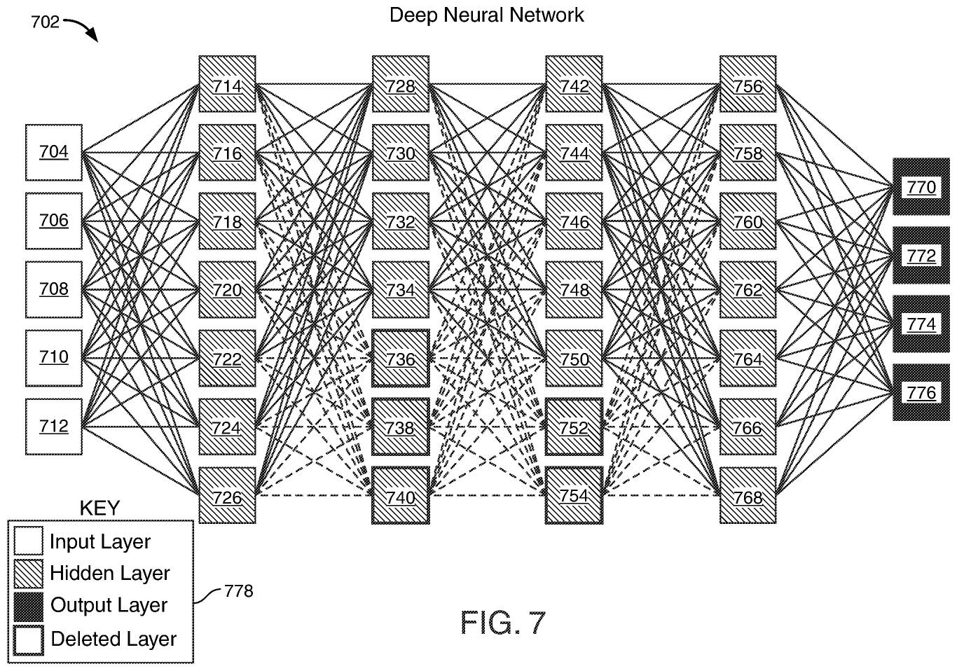

FIG. 7 shows illustrative diagram of deep neural network 702. Deep neural network 702 may be an AI model, like AI model 502 and 602. Deep neural network 702 may include data points. A deep neural network may include a plurality of layers. Each layer may add a complexity to the AI model. The layers may enable the AI model to process the inputs concisely and generate an appropriate output.

Each of the data points included in the deep neural network may have received data. Each of the data points included in the deep neural network may have been weighted according to the data received. The data receiving and weighting of the data points may be included in training process of the AI model. The received data may be encoded within the data point.

Key 778 shows the key to the data points included in deep neural network 702. Deep neural network 702 may have an input layer. Deep neural network 702 may have multiple hidden layers. The multiple hidden layers may make deep neural network 702 a deep neural network. Deep neural network 702 may include an output layer. Deep neural network 702 may include a deleted layer. There may be data points included in each of input layer, hidden layers and output layer. There may be data points deleted from the deleted layer.

The input layer may include data points 704, 706, 708, 710 and 712. Data points 704, 706, 708, 710 and 712 may generate outputs. The outputs generated by data points 704, 706, 708, 710 and 712 may be inputted into the first layer of the hidden layers.

The hidden layers may include data points 714, 716, 718, 720, 722, 724, 726, 728, 730, 732, 734, 736, 738, 740, 742, 744, 746, 748, 750, 752, 754, 756, 758, 760, 762, 764, 766 and 768. Data points 714, 716, 718, 720, 722, 724 and 726 may be included in the first layer of the hidden layers. Data points 728, 730, 732, 734, 736, 738 and 740 may be included in the second layer of the hidden layers. Data points 742, 744, 746, 748, 750, 752 and 754 may be included in the third layer of the hidden layers. Data points 756, 758, 760, 762, 764, 766 and 768 may be included in the fourth layer of the hidden layers.

Hidden layers in a neural network may not receive an input from a source external to the neural network and may not generate an output from a source external to the neural network. Hidden layers may be the intermediary layers in a neural network. Hidden layers may learn the intricate structures in data. Hidden layers may process images, speech recognition and other suitable tasks. An increase in the number of hidden layers may generate an increase in concise and appropriate outputs.

The output layer may include data points 770, 772, 774 and 776. Data points 770, 772, 774 and 776 may be the data points that generate an output to a query and/or stream of queries. The query or stream of queries may have been received at the input layer of deep neural network 702. Deep neural network 702 may have executed a search to respond to the received queries.

It should be noted that there may be additional layers within an AI model. There may be additional data points within an AI model. The initial AI model is not limited to the size of the neural network shown in FIG. 7.

The solid lines connecting the different data points may include algorithms. Algorithms may be created using a series of binary instructions, used to solve problems or perform tasks. Algorithms may include instructions of how to decode and process output data included in the data points. The algorithms may have been weighted. The algorithms may have been weighted based on the training of the AI model.

The deleted layer may include data points 736, 738. 740, 752, and 754. The broken lines may show algorithms that have since been deleted. Algorithms may have been deleted in response to identifying that the algorithms are not being used to generate a response to an input query. Algorithms may have been deleted in response to identifying that the algorithms are being used to generate a skewed response to an input query. Data points may also be deleted. In response to detecting that data points are used to generate a skewed response data points may be deleted. As such, data points 736, 738. 740, 752, and 754 may be deleted.

Thus, methods and apparatus for ARTIFICIAL INTELLIGENCE (“AI”) GUARDRAILS CREATED USING QUANTUM COMPUTING are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for maintaining a stable artificial intelligence (“AI”) model, the AI model operating on a silicon-based computing platform, the method using a quantum computing platform, the method comprising:
executing the AI model;
identifying one or more data points and algorithms for use in maintaining the AI model at a stable operating level, the identifying using the quantum computing platform, the identifying being executed in parallel with the executing of the AI model, the identifying comprising:
capturing training data used to train the AI model;
detecting an input query, the input query being a prompt entered into an input field of the AI model;
in response to detecting the input query, tracking the AI model as the AI model generates a response to the input query, the tracking comprising:
identifying a plurality of data points, from the training data, used to generate the response; and
monitoring a plurality of algorithms, executing within the AI model, used to generate the response;
based on the tracking, generating a simulated response, the simulated response being generated by simulating the AI model, the simulated response being a quantum-based response;
receiving from the silicon-based computing platform, a response to the input query, the response generated by the AI model, the response being an AI-based response;
comparing the quantum-based response with the AI-based response;
in response to the comparing, identifying:
AI-based deviations, the AI-based deviations being included in a first subset of the plurality of data points and algorithms, the first subset corresponding to the AI-based response;
quantum-based deviations, the quantum-based deviations being included in a second subset of the plurality of data points and algorithms, the second subset corresponding to the quantum-based response; and
a shared set of parameters, the shared set of parameters included in a third subset of the plurality of data points and algorithms, the third subset corresponding to overlap between the AI-based response and the quantum-based response;
transmitting the AI-based deviations, the quantum-based deviations and the shared set of parameters from the quantum computing platform to the silicon-based computing platform; and
creating a guardrail using the AI-based deviations, the quantum-based deviations and the shared set of parameters, the guardrail being used to maintain the AI model at the stable operating level, the guardrail including a set of conditions, the set of conditions configured to:
delete the first subset and the second subset from the plurality of data points and algorithms; and
confirm and score data points and algorithms that are determined to be included in the third subset.

2. The method of claim 1 wherein when the set of conditions is a first set of conditions, the method further including updating the guardrail with a second set of conditions, the second set of conditions determined based on subsequent input queries input into the AI model.

3. The method of claim 2 wherein the second set of conditions does not overlap with the first set of conditions.

4. The method of claim 1 wherein the AI-based deviations do not overlap with the quantum-based deviations.

5. The method of claim 1 wherein simulating the AI model includes:
copying the plurality of data points used to generate the AI-based response; and
recreating the copied data points using qubits.

6. The method of claim 5 wherein simulating the AI model further includes:
copying the plurality of algorithms used to generate the AI-based response; and
recreating the copied algorithms using quantum algorithms.

7. An apparatus for maintaining a stable artificial intelligence (“AI”) model, the apparatus comprising:
a silicon-based computing platform, the silicon-based computing platform configured to operate the AI model;
a quantum computing platform, the quantum computing platform including a quantum processor, the quantum computing platform configured to:
capture training data used to train the AI model;
detect an input query, the input query being a prompt entered into an input field of the AI model;
in response to a detection of the input query:
identify a plurality of data points, from the training data, used by the AI model to generate a response to the input query; and
monitor a plurality of algorithms executing within the AI model, the algorithms used by the AI model to generate the response to the input query;
generate a simulated response, the simulated response being generated by simulating the AI model, the simulated response being a quantum-based response;
receive from the silicon-based computing platform, a response to the input query, the response generated by the AI model, the response being an AI-based response;
execute a comparison between the quantum-based response and the AI-based response;
in response to execution of the comparison, identify:
AI-based deviations, the AI-based deviations being included in a first subset of the plurality of data points and algorithms, the first subset corresponding to the AI-based response;
quantum-based deviations, the quantum-based deviations being included in a second subset of the plurality of data points and algorithms, the second subset corresponding to the quantum-based response; and
a shared set of parameters, the shared set of parameters included in a third subset of the plurality of data points and algorithms, the third subset corresponding to overlap between the AI-based response and the quantum-based response;
transmit the AI-based deviations, the quantum-based deviations and the shared set of parameters from the quantum computing platform to the silicon-based computing platform; and
the silicon-based computing platform being configured to use the AI-based deviations, the quantum-based deviations and the shared set of parameters to create a guardrail, the guardrail being used to maintain the AI model at a stable operating level, the guardrail including a set of conditions, the set of conditions configured to:
delete one or more data points and algorithms that are determined to be within a predetermined threshold of the AI-based deviations and the quantum-based deviations; and
confirm and score one or more data points and algorithms that are determined to be within a predetermined threshold of the shared set of parameters.

8. The apparatus of claim 7 wherein when the set of conditions is a first set of conditions, the quantum computing platform further configured to update the guardrail with a second set of conditions, the second set of conditions determined based on subsequent input queries input into the AI model.

9. The apparatus of claim 8 wherein the second set of conditions does not overlap with the first set of conditions.

10. The apparatus of claim 7 wherein the AI-based deviations do not overlap with the quantum-based deviations.

11. The apparatus of claim 7 wherein to simulate the AI model, the quantum computing platform is configured to:
copy the plurality of data points used to generate the AI-based response; and
recreate the copied data points using qubits.

12. The apparatus of claim 7 wherein to simulate the AI model, the quantum computing platform is configured to:
copy the plurality of algorithms used to generate the AI-based response; and
recreate the copied algorithms using quantum algorithms.

13. A method for maintaining a stable artificial intelligence (“AI”) model, the AI model operating on a silicon-based computing platform, the method using a quantum computing platform, the method comprising:
identifying one or more data points and algorithms for maintaining the AI model at a stable operating level, the identifying using the quantum computing platform, the identifying being executed in parallel with executing the AI model, the identifying comprising:
capturing training data used to train the AI model;
detecting an input query, the input query being a prompt entered into an input field of the AI model;
in response to detecting the input query, tracking the AI model as the AI model generates a response to the input query, said tracking comprising:
identifying a plurality of data points, from the training data, used to generate the response; and
monitoring a plurality of algorithms, executing within the AI model, used to generate the response as the algorithms are being dynamically updated;
based on the tracking, generating a simulated response, the simulated response being generated by simulating the AI model, the simulated response being a quantum-based response;
receiving from the silicon-based computing platform, a response to the input query, the response generated by the AI model, the response being an AI-based response;
comparing the quantum-based response to the AI-based response;
in response to the comparing, identifying:
AI-based deviations, the AI-based deviations being included in a first subset of the plurality of data points and algorithms, the first subset corresponding to the AI-based response;
quantum-based deviations, the quantum-based deviations being included in a second subset of the plurality of data points and algorithms, the second subset corresponding to the quantum-based response; and
a shared set of parameters, the shared set of parameters included in a third subset of the plurality of data points and algorithms, the third subset corresponding to overlap between the AI-based response and the quantum-based response;
transmitting the AI-based deviations, the quantum-based deviations and the shared set of parameters from the quantum computing platform to the silicon-based computing platform; and
creating a guardrail using the AI-based deviations, the quantum-based deviations and the shared set of parameters, the guardrail being used to maintain the AI model at a stable operating level, the guardrail including a set of conditions, the set of conditions configured to:
identify data points and algorithms that are included in the first subset and the second subset; and
identify data points and algorithms that are included in the third subset.

14. The method of claim 13 wherein when the set of conditions is a first set of conditions, the method further including updating the guardrail with a second set of conditions, the second set of conditions determined based on subsequent input queries input into the AI model.

15. The method of claim 14 wherein the second set of conditions does not overlap with the first set of conditions.

16. The method of claim 13 wherein the AI-based deviations do not overlap with the quantum-based deviations.

17. The method of claim 13 wherein simulating the AI model includes:
copying the plurality of data points used to generate the AI-based response; and
recreating the copied data points using qubits.

18. The method of claim 17 wherein simulating the AI model further includes:
copying the plurality of algorithms used to generate the AI-based response; and
recreating the copied algorithms using quantum algorithms.

19. The method of claim 13 further including deleting data points and algorithms that are identified as being included in the first subset and the second subset.

20. The method of claim 13 further including confirming and scoring the data points and algorithms that are included in the third subset.
